(19) United States
(12) Patent Application Publication
(10) Pub. No.: US 2024/0268475 A1
(43) Pub. Date: Aug. 15, 2024

(54) AEROSOL GENERATING DEVICE FOR DETECTING USER'S INHALATION AND OPERATING METHOD THEREOF

(71) Applicant: KT&G CORPORATION, Daejion (KR)

(72) Inventors: Yong Hwan KIM, Gyeonggi-do (KR); Dong Sung KIM, Seoul (KR); Hun ll LIM, Seoul (KR); Seok Su JANG, Daejeon (KR)

(73) Assignee: KT&G CORPORATION, Daejion (KR)

(21) Appl. No.: 18/567,901

(22) PCT Filed: Jan. 6, 2023
(86) PCT No.: PCT/KR2023/000274

§ 371 Date: Dec. 7, 2023

(30) Foreign Application Priority Data
Jan. 7, 2022 (KR) 10-2022-0002781

(51) Int. Cl. A24F 40/51; A24F 40/42; A24F 40/465; A24F 40/53; A24F 40/60

(52) U.S. Cl. CPC A24F 40/51; A24F 40/53; A24F 40/60; A24F 40/42; A24F 40/465

(57) ABSTRACT

An aerosol-generating device includes a heater configured to heat at least a portion of an aerosol-generating product, a sensor configured to detect a user's puff, and a processor electrically connected to the heater and the sensor, wherein the processor is configured to obtain first remaining puff data based on pressure change data obtained through the sensor, when the first remaining puff data satisfies a preset condition and a user input is received, obtain data regarding an inhalation pattern based on the pressure change data, and supply power to the heater by changing the first remaining puff data to second remaining puff data based on the data regarding the inhalation pattern. Various embodiments may be made.

### TECHNICAL FIELD

One or more embodiments relate to an electronic device capable of changing remaining puff data based on an inhalation pattern of a user, and an operating method of the electronic device.

### BACKGROUND ART

Recently, the demand for alternative methods to overcome the shortcomings of general cigarettes has increased. For example, there is an increasing demand for a system of generating aerosol by heating cigarettes or an aerosol-generating material by using an aerosol-generating device, rather than by burning cigarettes.

When an aerosol-generating product is inserted into an accommodation space, an aerosol-generating device may heat the aerosol-generating product according to a preset temperature profile. In this case, as user's inhalation is detected by a puff sensor, the aerosol-generating device may supply power to a heater based on the preset temperature profile.

The number of puffs (e.g., 14 times) preset for one aerosol-generating product may be stored in the aerosol-generating device, and when the preset number of puffs is reached, the aerosol-generating device may stop heating the aerosol-generating product. The number of puffs preset for one aerosol-generating product may denote the number of times that an optimum smoking taste may be provided by the aerosol-generating product when a user smokes.

### DISCLOSURE

### Technical Problem

An existing aerosol-generating device may provide the fixed number of puffs for one aerosol-generating product, and when the fixed number of puffs is detected, the aerosol-generating device stops heating the aerosol-generating product, and the inserted aerosol-generating product is discarded. Although an aerosol inhalation intensity, a puff interval, a puff duration, etc. during smoking differ depending on users, providing a constant number of puffs may degrade the smoking satisfaction of the users and aerosol-generating products may be wasted.

Therefore, one or more embodiments of the disclosure provide remaining puff data changed based on an inhalation pattern of the user.

The technical problems of the disclosure are not limited to the aforementioned description and technical problems that are not stated may be clearly understood by one of ordinary skill in the art from the embodiments described hereinafter and the attached drawings.

### Technical Solution

According to one or more embodiments, an aerosol-generating device includes a heater configured to heat at least a portion of an aerosol-generating product, a sensor configured to detect a user's puff, and a processor electrically connected to the heater and the sensor, wherein the processor is configured to obtain first remaining puff data based on pressure change data obtained through the sensor, when the first remaining puff data satisfies a preset condition and a user input is received, obtain data regarding an inhalation pattern based on the pressure change data, and supply power to the heater by changing the first remaining puff data to second remaining puff data based on the data regarding the inhalation pattern.

According to one or more embodiments, an operating method of an aerosol-generating device includes obtaining first remaining puff data based on pressure change data obtained through the sensor, when the first remaining puff data satisfies a preset condition and a user input is received, obtaining data regarding an inhalation pattern based on the pressure change data, and supplying power to the heater by changing the first remaining puff data to second remaining puff data based on the data regarding the inhalation pattern.

### Advantageous Effects

According to one or more embodiments, appropriate additional smoking may be provided to a user as an additional heating time and/or additional puffs are reflected based on an inhalation pattern of the user.

According to one or more embodiments, as appropriate additional smoking is provided to each user, the smoking satisfaction of the user may be improved, and an aerosol-generating product that is not fully consumed may not be wasted.

Effects of the embodiments are not limited to those stated above, and effects that are not described herein may be clearly understood by one of ordinary skill in the art from the present specification and the attached drawings.

### DESCRIPTION OF DRAWINGS

FIG. 1 is a block diagram of an aerosol-generating device according to an embodiment.

FIG. 2 is a flowchart illustrating a method of changing puff data in an aerosol-generating device, according to an embodiment.

FIG. 3 is a graph showing a pressure drop detected by a sensor of an aerosol-generating device, according to an embodiment.

FIG. 4 is a graph obtained after Digital Signal filter Processing (DSP) is performed on the graph of FIG. 3.

FIG. 5 is a graph showing a pressure variation during one puff in the graph of FIG. 4.

FIG. 6 is a graph showing the accumulation of pressure variation during multiple puffs in the graph of FIG. 4.

FIG. 7 is a detailed flowchart showing change of puff data in an aerosol-generating device, according to an embodiment.

FIG. 8 shows an example of a point in time when an aerosol-generating device obtains data regarding an inhalation pattern.

FIG. 9A shows an example of a first user interface output by an aerosol-generating device through a display, according to an embodiment.

FIG. 9B shows an example of a second user interface changed according to a user input regarding the first user interface of FIG. 9A.

FIG. 9C shows an example of a third user interface changed from the second user interface of FIG. 9B.

FIG. 10 is a block diagram of an aerosol-generating device according to another embodiment.

### BEST MODE

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the suspector may be a magnetic body that generates heat by an external magnetic field. As the suspector is positioned inside the coil and a magnetic field is applied to the suspector, the suspector generates heat to heat an aerosol generating article. In addition, optionally, the suspector may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, one or more embodiments of the disclosure are described in detail with reference to the attached drawings.

FIG. 1 is a block diagram of an aerosol-generating device according to an embodiment.

Referring to FIG. 1, an aerosol-generating device 100 may include a processor 110, a heater 120, and a sensor 130. However, hardware components in the aerosol-generating device 100 are not limited to those shown in FIG. 1. According to the design of the aerosol-generating device 100, it will be understood by one of ordinary skill in the art that some of the hardware components shown in FIG. 1 may be omitted or new components may be added.

Hereinafter, an operation of each of the components will be described without being limited to a location in a particular space in which the aerosol-generating device 100 is located.

In an embodiment, the heater 120 may heat at least a portion of an aerosol-generating product inserted into the aerosol-generating device 100. For example, the heater 120 may receive power from a battery (not shown) according to the control of the processor 110 and heat at least a portion of the aerosol-generating product with the received power, thereby generating aerosol.

In an embodiment, the sensor 130 may detect a user's puff and transmit detected information to the processor 110.

In an embodiment, the sensor 130 may be a pressure sensor that detects a user's puff by measuring a pressure according to an air flow change inside an aerosol-generating device. For example, the sensor 130 may be arranged in an air flow passage, an end of an opening, etc. in the aerosol-generating device 100 to measure an internal pressure of the aerosol-generating device 100, but the location of the sensor 130 is not limited thereto. In this case, the sensor 130 may be any one of an absolute pressure sensor, a gauge pressure sensor, and a differential pressure sensor.

In an embodiment, the sensor 130 may detect a pressure drop according to the user's inhalation. In an embodiment, the sensor 130 may compare the detected pressure drop (that is, a difference between pressure values) with a preset threshold difference and thus detect whether the user puffs. For example, the sensor 130 may detect the user's puff when a difference between the detected pressure values is greater than the preset threshold difference. Also, the sensor 130 may transmit, to the processor 110, data regarding whether the user puffs.

However, one or more embodiments are not limited thereto. The sensor 130 may transmit, to the processor 110, pressure values detected before and after the user's inhalation, and the processor 110 may compare a difference between received pressure values with the preset threshold difference to thus detect the user's puff.

In an embodiment, the processor 110 may obtain first remaining puff data based on pressure change data obtained through the sensor 130. In the present specification, the term “remaining puff data” may indicate the number of remaining puffs that a user may inhale one aerosol-generating product and/or a remaining heating time of a temperature profile set for the aerosol-generating product. For example, when the maximum number of puffs preset for one aerosol-generating product is 14, and when the number of puffs that the user already inhaled is 10, the remaining puff data may include data regarding the number of remaining puffs, that is, 4. Also, in the present specification, the expression “first remaining puff data” may indicate remaining puff data to which data regarding an inhalation pattern of the user is not reflected.

The processor 110 may count the number of puffs by detecting a user's puffs, based on the pressure change data obtained through the sensor 130. In this case, the processor 110 may obtain, as the number of remaining puffs, a value obtained by subtracting the counted number of puffs from the maximum number of puffs that is preset for the aerosol-generating product inserted into the aerosol-generating device 100.

The processor 110 may count the number of puffs by detecting a user's puffs, based on the pressure change data obtained through the sensor 130. In this case, the processor 110 may obtain a remaining heating time corresponding to the counted number of puffs from a temperature profile regarding the heater 120.

In an embodiment, when the first remaining puff data satisfies a preset condition and a user input is received, the processor 110 may obtain the data regarding the inhalation pattern. In the present specification, the term “data regarding an inhalation pattern” may indicate data including at least one of an amount of a pressure change per puff of a certain user, a puff duration, and a puff interval.

For example, the above preset condition may include a case where the number of remaining puffs of the first remaining puff data equals to the preset number of puffs (e.g., three times) and/or a case where a remaining heating time of the first remaining puff data equals to a preset time (e.g., 30 seconds). When the number of remaining puffs of the first remaining puff data equals to the preset number of puffs, which is three, the processor 110 may detect whether a user input is received, and when the user input is received within certain time, the processor 110 may obtain the data regarding the inhalation pattern based on the pressure change data. An example in which the processor 110 obtains the data regarding the inhalation pattern based on the pressure change data is described in detail below with reference to FIG. 7.

In an embodiment, the processor 110 may change the first remaining puff data to second remaining puff data based on the obtained data regarding the inhalation pattern and supply power to the heater 120 based on the second remaining puff data. In the present specification, the expression “second remaining puff data” may indicate remaining puff data changed as data regarding an inhalation pattern of a user is reflected.

For example, an inhalation pattern obtained based on the pressure change data may be a first inhalation pattern, and when the first inhalation pattern is compared with a reference pattern, the first inhalation pattern may be an inhalation pattern in which a degree of one inhalation (that is, an amount of a pressure change during one puff) is low. In this case, the processor 110 may change the first remaining puff data to the second remaining puff data corresponding to the first inhalation pattern.

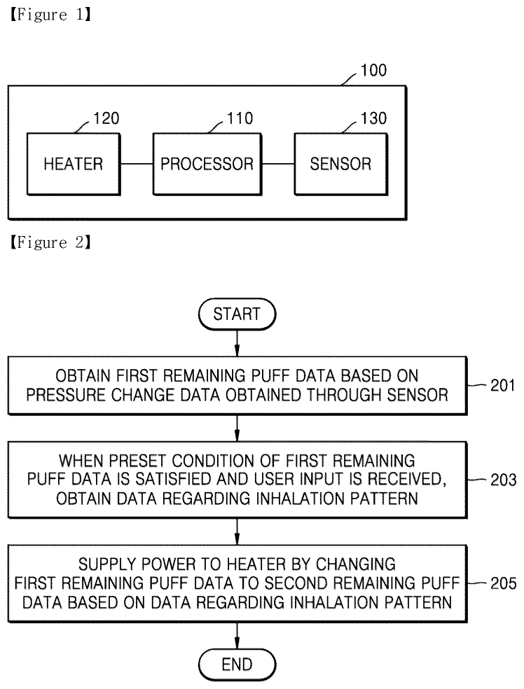

FIG. 2 is a flowchart illustrating a method of changing puff data in an aerosol-generating device, according to an embodiment.

Referring to FIG. 2, in operation 201, a processor (e.g., the processor 110 of FIG. 1) may obtain first remaining puff data based on pressure change data obtained through a sensor (e.g., the sensor 130 of FIG. 1).

In an embodiment, the processor 110 may obtain the pressure change data through the sensor 130.

For example, the pressure change data obtained through the sensor 130 may be data obtained by filtering raw data of internal pressure values of an aerosol-generating device (e.g., the aerosol-generating device 100 of FIG. 1) output from the sensor 130. For example, the processor 110 may obtain the pressure change data by performing digital signal filter processing (DSP) on the raw data of the internal pressure values output from the sensor 130.

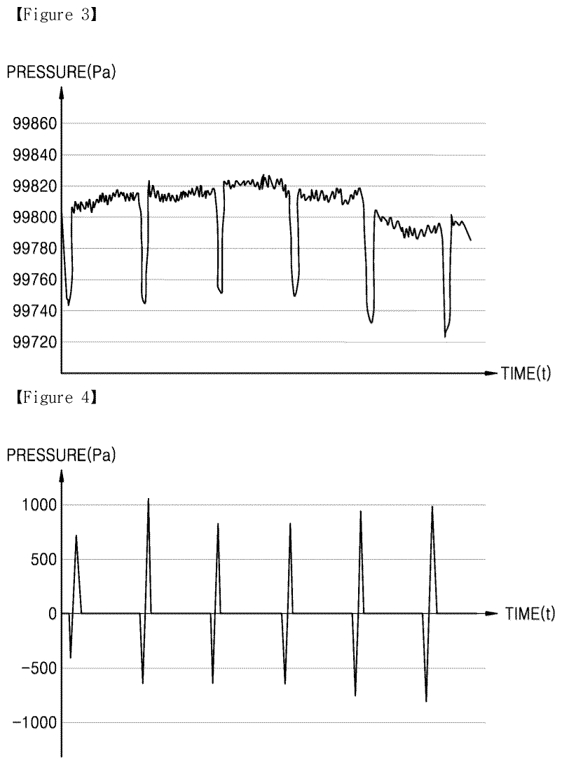

As another example, the pressure change data obtained through the sensor 130 may be data obtained by accumulating for a certain period of time data processed based on an absolute value of the pressure change. That is, throughout the specification, the term “pressure change data” may indicate at least one of data, in which pressure values output from the sensor 130 are filtered, and the data accumulated for a certain period of time. The pressure change data is described below in detail with reference to FIGS. 3 to 6.

In an embodiment, the processor 110 may obtain the first remaining puff data based on the pressure change data. For example, the processor 110 may count the number of puffs by detecting the user's puffs based on the pressure change data obtained through the sensor 130. In this case, the processor 110 may obtain, as the number of remaining puffs (e.g., four times), a value obtained by subtracting the counted number of puffs (e.g., 10 times) from the maximum number of puffs (e.g., 14 times) that is preset for the aerosol-generating product inserted into the aerosol-generating device 100. Also, the processor 110 may obtain a remaining heating time (e.g., 40 seconds) corresponding to the counted number of puffs (e.g., 10 times) from the temperature profile regarding the heater 120.

According to an embodiment, when a preset condition regarding the first remaining puff data is satisfied and a user input is received, the processor 110 may obtain the data regarding the inhalation pattern in operation 203.

In an embodiment, the processor 110 may determine whether the first remaining puff data satisfies the preset condition. In this case, the term “preset condition” may indicate a situation where smoking of one aerosol-generating product is expected to be terminated soon. For example, when the total number of puffs for one aerosol-generating product is preset to be 14, and when the number of remaining puffs for the aerosol-generating product is 3, the preset condition may be met for a situation where a user's smoking action is to be terminated soon. As another example, when the total heating time for one aerosol-generating product is preset to be 5 minutes, and when the remaining heating time for the aerosol-generating product is 30 seconds, the preset condition may be met for a situation where a user's smoking action is to be terminated soon. That is, in the above examples, the term “preset condition” may include that the number of remaining puffs is 3 and/or a remaining heating time is 30 seconds.

In an embodiment, the processor 110 may determine whether a user input is received through a display (not shown). For example, when the first remaining puff data satisfies the preset condition, the processor 110 may output a user interface that guides a user input through the display. Then, when the user input is received through the user interface output on the display, the processor 110 may obtain the data regarding the inhalation pattern based on the pressure change data obtained through the sensor 130.

In the present embodiment, when the user input is received, the data regarding the inhalation pattern of the user may be obtained. The processor 110 may obtain the data regarding the inhalation pattern of the user based on the pressure change data obtained through the sensor 130. In this case, because the data regarding the inhalation pattern includes at least one of an amount of a pressure change per puff, a puff duration, and a puff interval, the processor 110 needs to obtain the data regarding the inhalation pattern by performing a separate arithmetic operation on a series of values in the pressure change data. That is, the processor 110 may effectively reduce the power required for the arithmetic operation by performing the arithmetic operation only when a user input for changing remaining puff data by reflecting the user's inhalation pattern is received, and spatial efficiency according to the miniaturization of computing devices (e.g., processors) may be improved.

According to an embodiment, in operation 205, the processor 110 may change the first remaining puff data to the second remaining puff data based on the data regarding the inhalation pattern and may supply power to the heater (e.g., the heater 120 of FIG. 1) based on the second remaining puff data.

In an embodiment, the processor 110 may obtain the data regarding the inhalation pattern based on at least one of the amount of the pressure change per puff, the puff duration, and the puff interval which are included in the pressure change data. For example, the processor 110 may obtain an inhalation pattern in which an amount of a pressure change in one puff is about 60 Pa. The processor 110 may change the first remaining puff data to the second remaining puff data by reflecting the obtained inhalation pattern in the first remaining puff data that is existing remaining puff data.

FIG. 3 is a graph showing a pressure drop detected by a sensor of an aerosol-generating device, according to an embodiment.

Referring to FIG. 3, the graph showing the pressure drop detected by the sensor may be a graph showing raw data of internal pressure values of the aerosol-generating device (e.g., the aerosol-generating device 100 of FIG. 1).

In an embodiment, the sensor (e.g., the sensor 130 of FIG. 1) may detect a pressure drop according to the user's inhalation. For example, when a user inhales (that is, puffs) on an aerosol-generating product inserted into the aerosol-generating device 100, the sensor 130 may detect a pressure value of about 99,800 Pa before the user's inhalation and a pressure value of about 99,745 Pa after the user's inhalation.

In an embodiment, the sensor 130 may transmit the pressure values before and after the user's inhalation to the processor (e.g., the processor 110 of FIG. 1), and the processor 110 may obtain a difference between received pressure values. For example, the processor 110 may obtain that the difference between the pressure values obtained through the sensor 130 is about 55 Pa (=99,800 Pa−99,745 Pa). Then, the processor 110 may detect whether the user has puffed by comparing the detected difference between the pressure values with a preset threshold difference (e.g., 20 Pa). In the graph of FIG. 3, for example, the number of times that the detected difference between the pressure values exceeds the preset threshold difference (i.e., about 20 Pa) is six in total. Therefore, the processor 110 may determine that the number of user's puffs is six.

FIG. 4 is a graph obtained after DSP is performed on the graph of FIG. 3.

Referring to FIG. 4, a processor (e.g., the processor 110 of FIG. 1) may perform DSP on raw data of internal pressure values of an aerosol-generating device (e.g., the aerosol-generating device 100 of FIG. 1) output from a sensor (e.g., the sensor 130 of FIG. 1).

In an embodiment, the processor 110 may filter signals output from the sensor 130 after digital processing performed by an analog-to-digital converter (ADC) and analog processing performed by a digital-to-analog converter (DAC). For example, the processor 110 may convert an analog signal, which is the raw data of the internal pressure values of the aerosol-generating device 100, into a digital signal by using the ADC. As the analog signal is converted into the digital signal, pieces of data corresponding to noise signals shown in the graph of FIG. 3 may have a value of 0. Also, as the analog signal is converted into the digital signal, pieces of data corresponding to peak signals shown in the graph of FIG. 3 may have a continuous number of values. Then, to output a DSP result in the form of an analog signal, the processor 110 may convert the digital signal into an analog signal through the DAC. In the graph of FIG. 4, the number of times that output signals are changed is six in total, and the processor 110 may determine that the number of user's puffs is six.

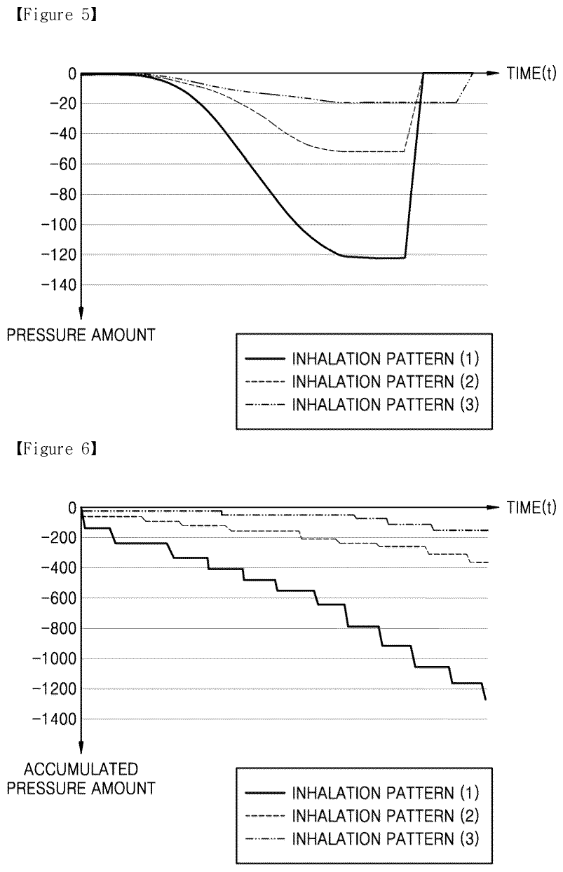

FIG. 5 is a graph showing a pressure variation during one puff in the graph of FIG. 4.

FIG. 5 is a graph showing a pressure variation during one of the multiple puffs in data after DSP of FIG. 4. In this case, the graph may include a plurality of inhalation patterns (e.g., an inhalation pattern 1, an inhalation pattern 2, and an inhalation pattern 3) having different pressure variations in the same puff section

In an embodiment, a processor (the processor 110 of FIG. 1) may obtain data regarding an inhalation pattern, based on pressure change data obtained through a sensor (e.g., the sensor 130 of FIG. 1). For example, the processor 110 may obtain a maximum value of a pressure variation and the data regarding the inhalation pattern. As another example, the processor 110 may also obtain the data regarding the inhalation pattern by obtaining an accumulated value of the pressure variation.

Among the inhalation patterns, the pressure variation may decrease in an order of an inhalation pattern 1, an inhalation pattern 2, and an inhalation pattern 3.

Among the inhalation patterns, the inhalation pattern 1 having the greatest pressure variation may have the highest intensity of inhalation in one puff (that is, the intensity of the user's puff on the aerosol-generating product). In this case, the processor 110 may obtain the data regarding the inhalation pattern 1, based on the pressure change data. For example, the processor 110 may obtain a maximum value of the pressure variation obtained through the sensor 130. In this case, because the pressure variation obtained through the sensor 130 has a negative value, the maximum value may be an absolute value of a minimum value (e.g., an absolute value ‘122 Pa’ of a minimum value ‘−122 Pa’ of the inhalation pattern 1) and thus may obtain the data regarding the inhalation pattern 1. As another example, the processor 110 may obtain the data regarding the inhalation pattern 1 by obtaining an accumulated value of the pressure variation obtained through the sensor 130 (e.g., an integral value of the inhalation pattern 1 in one puff section).

Among the inhalation patterns, the inhalation pattern 3 having the smallest pressure variation may have the lowest intensity of the user's inhalation in one puff. In this case, the processor 110 may obtain data regarding the inhalation pattern 3 based on the pressure change data. For example, the processor 110 may obtain a maximum value of the pressure variation obtained through the sensor 130. In this case, because the pressure variation obtained through the sensor 130 has a negative value, the maximum value may be an absolute value of a minimum value (e.g., an absolute value ‘20 Pa’ of a minimum value ‘−20 Pa’ of the inhalation pattern 3) and thus may obtain the data regarding the inhalation pattern 3. As another example, the processor 110 may obtain the data regarding the inhalation pattern 3 by obtaining an accumulated value of the pressure variation obtained through the sensor 130 (e.g., an integral value of the inhalation pattern 3 in one puff section).

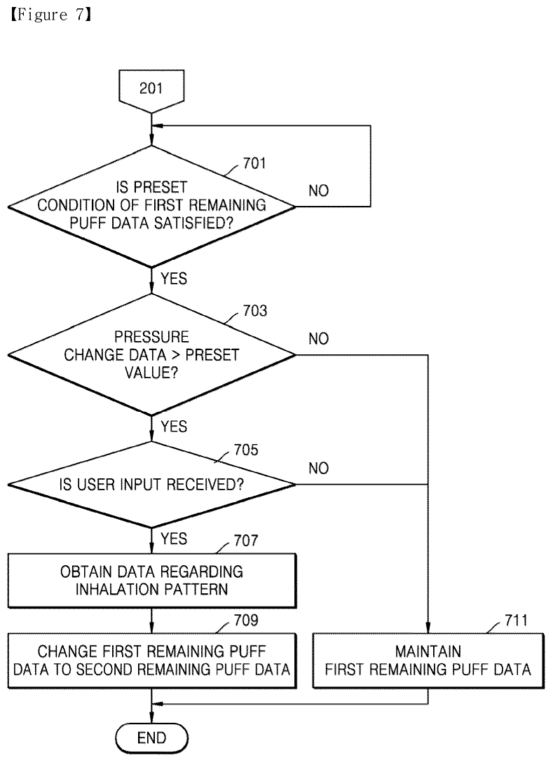

FIG. 6 is a graph showing the accumulation of pressure variation during multiple puffs in the graph of FIG. 4.

FIG. 6 is a graph showing the accumulation of pressure variations of multiple puffs in the data on which the DSP of FIG. 4 is performed. That is, the graph may be a graph showing data regarding the accumulation of the pressure variation during a certain period of time. In this case, the graph may include a plurality of inhalation patterns (e.g., an inhalation pattern 1, an inhalation pattern 2, and an inhalation pattern 3) having different pressure variations.

In an embodiment, a processor (e.g., the processor 110 of FIG. 1) may obtain the data regarding the inhalation pattern based on the pressure change data obtained through a sensor (e.g., the sensor 130 of FIG. 1). For example, the processor 110 may obtain the data regarding the inhalation pattern by obtaining a maximum value of the pressure variation. As another example, the processor 110 may obtain the data regarding the inhalation pattern by obtaining the accumulated value of the pressure variation.

Among the inhalation patterns, the pressure variations may decrease in an order of the inhalation pattern 1, the inhalation pattern 2, and the inhalation pattern 3.

Among the inhalation patterns, the inhalation pattern 1 having the greatest pressure variation may have the highest intensity of the user's multiple puffs (that is, the intensity with which the user inhales aerosol generated from the aerosol-generating product). In this case, the processor 110 may obtain the data regarding the inhalation pattern 1, based on the pressure change data. For example, the processor 110 may obtain a maximum value of the pressure variation obtained through the sensor 130. In this case, because the pressure variation obtained through the sensor 130 has a negative value, the maximum value may be an absolute value of a minimum value (e.g., an absolute value ‘1250 Pa’ of a minimum value ‘−1250 Pa’ of the inhalation pattern 1) and thus obtain data regarding the inhalation pattern 1. As another example, the processor 110 may obtain the data regarding the inhalation pattern 1 by obtaining an accumulated value of the pressure variation obtained through the sensor 130 (e.g., an integral value of the inhalation pattern 1 regarding the entire puff section).

Among the inhalation patterns, the inhalation pattern 3 having the smallest pressure variation may have the lowest intensity of inhalation in multiple puffs. In this case, the processor 110 may obtain data regarding the inhalation pattern 3 based on the pressure change data. For example, the processor 110 may obtain a maximum value of the pressure variation obtained through the sensor 130. In this case, because the pressure variation obtained through the sensor 130 has a negative value, the maximum value may be an absolute value of a minimum value (e.g., an absolute value ‘180 Pa’ of a minimum value ‘−180 Pa’ of the inhalation pattern 3) and thus obtain data regarding the inhalation pattern 3. As another example, the processor 110 may obtain the data regarding the inhalation pattern 3 by obtaining an accumulated value of the pressure variation obtained through the sensor 130 (e.g., an integral value of the inhalation pattern 3 regarding the entire puff section).

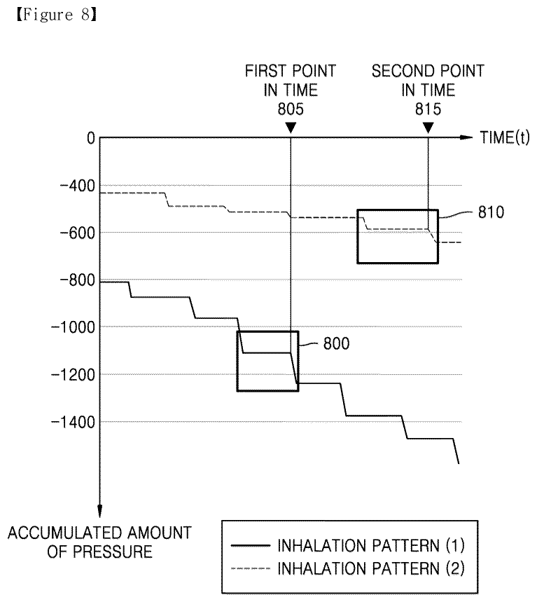

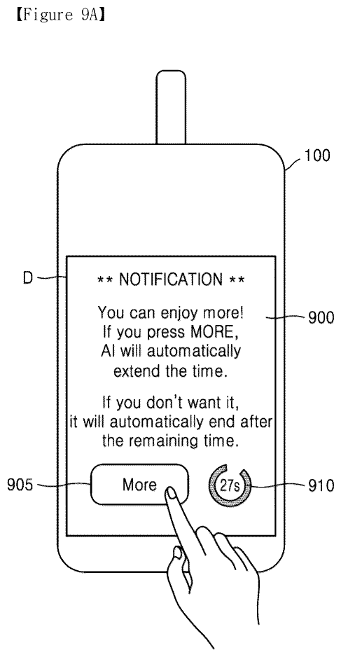

FIG. 7 is a detailed flowchart showing change of puff data in an aerosol-generating device, according to an embodiment. FIG. 8 shows an example of a point in time when an aerosol-generating device obtains data regarding an inhalation pattern. FIG. 7 is a flowchart for explaining in detail operations after operation 201 of FIG. 2.

Referring to FIG. 7, in operation 701, the processor (e.g., the processor 110 of FIG. 1) may determine whether the first remaining puff data satisfies the preset condition. In this case, the term “preset condition” may indicate a condition regarding a situation where a user is expected stop smoking one aerosol-generating product soon.

When the preset condition is a condition regarding the number of remaining puffs, the processor 110 may determine whether the number of remaining puffs of the first remaining puff data is the same as the number of remaining puffs of the preset condition.

For example, when the total number of puffs for one aerosol-generating product is preset to be 14, and when the number of remaining puffs of the preset condition is three, the processor 110 may determine that the first remaining puff data satisfies the preset condition in a point in time when an 11^{th} puff is terminated. Referring to FIG. 8, the processor 110 may detect an 11^{th} puff 800 of the inhalation pattern 1 and a first point in time 805 when the 11^{th} puff 800 is terminated and detect an 11^{th} puff 810 of the inhalation pattern 2 and a second point in time 815 when the 11^{th} puff 810 is terminated. The processor 110 may determine that the first remaining puff data satisfies the preset condition at the first point in time 805 and the second point in time 815.

According to an embodiment, in operation 703, the processor 110 may determine whether the pressure change data is greater than a preset value. For example, when the first remaining puff data satisfies the preset condition, the processor 110 may determine whether the pressure change data is greater than the preset value.

In an embodiment, the processor 110 may determine whether the pressure change data, which is obtained through the sensor 130 in operation 201 of FIG. 2, is greater than the preset value. In this case, the pressure change data includes an accumulated value of the pressure change obtained through an arithmetic operation performed on effective pressure change values, and the accumulated value of the pressure change is a negative value. Referring to FIG. 8, for example, the processor 110 may determine that an accumulated value (e.g., −1100 Pa) of the pressure change in the first point in time 805 is less than a preset value (e.g., −1000 Pa). As another example, the processor 110 may determine that the accumulated value (e.g., −590 Pa) of the pressure change in the second point in time 815 is greater than the preset value (e.g., −1000 Pa).

According to an embodiment, in operation 705, the processor 110 may determine whether a user input is received through the display. For example, the processor 110 may output a user interface that guides a user input through the display. When a user input is received through the user interface output through the display, the processor 110 may obtain the data regarding the inhalation pattern based on the pressure change data obtained through the sensor 130, in operation 707.

According to an embodiment, in operation 709, the processor 110 may change the first remaining puff data to the second remaining puff data based on the data regarding the inhalation pattern and supply power to a heater (e.g., the heater 120 of FIG. 1) based on the second remaining puff data. Referring to FIG. 8, for example, when a user input is received through the display after the second point in time 815 in the inhalation pattern 2, the processor 110 may change the first remaining puff data to the second remaining puff data by reflecting the data regarding the inhalation pattern 2 to the first remaining puff data.

According to an embodiment, when it is determined in operation 703 that the pressure change data is less than a preset value, or when the user input is not received through the display in operation 705, the processor 110 may maintain the first remaining puff data in operation 711 and supply power to the heater 120 based on the first remaining puff data. For example, referring to FIG. 8, when the user input is not received through the display in the inhalation pattern 1 or after the second point in time 815 of the inhalation pattern 2, the processor 110 may maintain the first remaining puff data.

In the present specification, however, because the pressure variation obtained through the sensor 130 has a negative value, and when the pressure change data is greater than the preset value, the first remaining puff data is changed to the second remaining puff data by reflecting the data regarding the inhalation pattern to the first remaining puff data. However, one or more embodiments are not limited thereto. In another embodiment, when the pressure variation obtained through the sensor 130 has a positive value, and when the pressure change data is less than the preset value, the first remaining puff data may be changed to the second remaining puff data by reflecting the data regarding the inhalation pattern to the first remaining puff data.

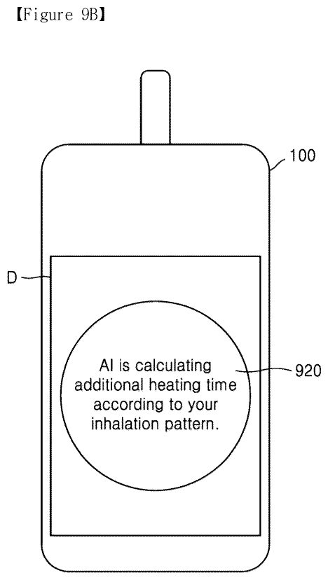

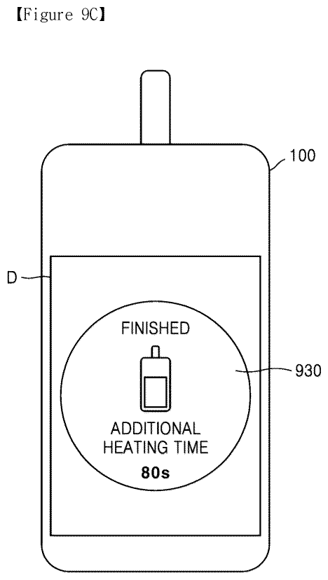

FIG. 9A shows an example of a first user interface output by the aerosol-generating device 100 through a display D, according to an embodiment.

Referring to FIG. 9A, the first user interface may include a user notification message 900, an object 905 for guiding a user input, and remaining puff data 910. For example, the remaining puff data 910 may be the first remaining puff data to which the data regarding the inhalation pattern of the user is not reflected. Referring to FIG. 9A, the remaining puff data 910 includes the remaining heating time indicated as ‘27 s,’ but one or more embodiments are not limited thereto. In another embodiment, the first user interface may include remaining puff data including the number of remaining puffs, such as ‘3 puffs.’

In an embodiment, when a user input regarding the object 905 for guiding a user input is received, the processor (e.g., the processor 110 of FIG. 1) may convert the first user interface into a second user interface.

FIG. 9B shows an example of a second user interface changed according to a user input regarding the first user interface of FIG. 9A.

Referring to FIG. 9B, the second user interface may include a user notification message 920. For example, the user notification message 920 may be displayed on the display D during a period of time when the processor (e.g., the processor 110 of FIG. 1) obtains the data regarding the inhalation pattern of the user and change the first remaining puff data to the second remaining puff data in operation 707 and operation 709 of FIG. 7.

In an embodiment, when the period of time when the data regarding the inhalation pattern of the user is obtained and the first remaining puff data is changed to the second remaining puff data has passed, the processor 110 may convert the second user interface into a third user interface.

FIG. 9C shows an example of a third user interface changed from the second user interface of FIG. 9B.

Referring to FIG. 9C, the third user interface may include remaining puff data 930. For example, the remaining puff data 930 may be the second remaining puff data that is changed after the data regarding the inhalation pattern of the user is reflected. Referring to FIG. 9C, the remaining puff data 930 includes the remaining heating time indicated as ‘80 seconds,’ but one or more embodiments are not limited thereto. In another embodiment, the third user interface may include the remaining puff data including the number of remaining puffs, such as ‘8 puffs.’

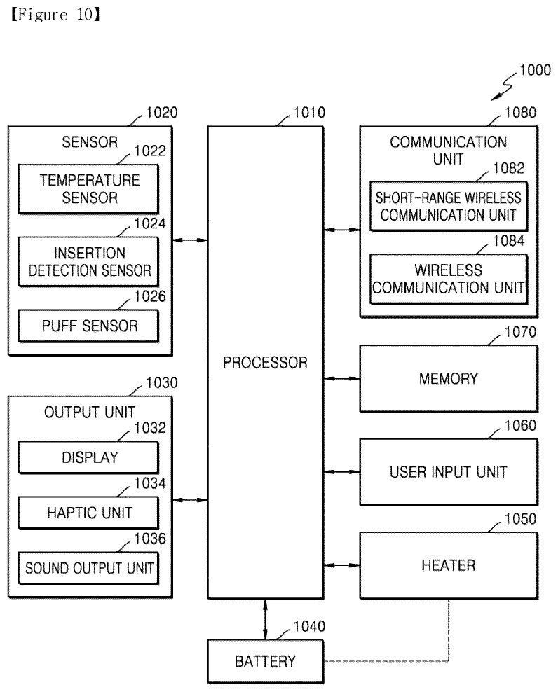

FIG. 10 is a block diagram of an aerosol generating device 1000 according to another embodiment.

The aerosol generating device 1000 may include a controller 1010, a sensing unit 1020, an output unit 1030, a battery 1040, a heater 1050, a user input unit 1060, a memory 1070, and a communication unit 1080. However, the internal structure of the aerosol generating device 1000 is not limited to those illustrated in FIG. 10. That is, according to the design of the aerosol generating device 1000, it will be understood by one of ordinary skill in the art that some of the components shown in FIG. 10 may be omitted or new components may be added.

The sensing unit 1020 may sense a state of the aerosol generating device 1000 and a state around the aerosol generating device 1000, and transmit sensed information to the controller 1010. Based on the sensed information, the controller 1010 may control the aerosol generating device 1000 to perform various functions, such as controlling an operation of the heater 1050, limiting smoking, determining whether an aerosol generating article (e.g., a cigarette, a cartridge, or the like) is inserted, displaying a notification, or the like.

The sensing unit 1020 may include at least one of a temperature sensor 1022, an insertion detection sensor, and a puff sensor 1026, but is not limited thereto.

The temperature sensor 1022 may sense a temperature at which the heater 1050 (or an aerosol generating material) is heated. The aerosol generating device 1000 may include a separate temperature sensor for sensing the temperature of the heater 1050, or the heater 1050 may serve as a temperature sensor. Alternatively, the temperature sensor 1022 may also be arranged around the battery 1040 to monitor the temperature of the battery 1040.

The insertion detection sensor 1024 may sense insertion and/or removal of an aerosol generating article. For example, the insertion detection sensor 1024 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1026 may sense a user's puff on the basis of various physical changes in an airflow passage or an airflow channel. For example, the puff sensor 1026 may sense a user's puff on the basis of any one of a temperature change, a flow change, a voltage change, and a pressure change.

The sensing unit 1020 may include, in addition to the temperature sensor 1022, the insertion detection sensor 1024, and the puff sensor 1026 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1030 may output information on a state of the aerosol generating device 1000 and provide the information to a user. The output unit 1030 may include at least one of a display unit 1032, a haptic unit 1034, and a sound output unit 1036, but is not limited thereto. When the display unit 1032 and a touch pad form a layered structure to form a touch screen, the display unit 1032 may also be used as an input device in addition to an output device.

The display unit 1032 may visually provide information about the aerosol generating device 1000 to the user. For example, information about the aerosol generating device 1000 may mean various pieces of information, such as a charging/discharging state of the battery 1040 of the aerosol generating device 1000, a preheating state of the heater 1050, an insertion/removal state of an aerosol generating article, or a state in which the use of the aerosol generating device 1000 is restricted (e.g., sensing of an abnormal object), or the like, and the display unit 1032 may output the information to the outside. The display unit 1032 may be, for example, a liquid crystal display panel (LCD), an organic light-emitting diode (OLED) display panel, or the like. In addition, the display unit 1032 may be in the form of a light-emitting diode (LED) light-emitting device.

The haptic unit 1034 may tactilely provide information about the aerosol generating device 1000 to the user by converting an electrical signal into a mechanical stimulus or an electrical stimulus. For example, the haptic unit 1034 may include a motor, a piezoelectric element, or an electrical stimulation device.

The sound output unit 1036 may audibly provide information about the aerosol generating device 1000 to the user. For example, the sound output unit 1036 may convert an electrical signal into a sound signal and output the same to the outside.

The battery 1040 may supply power used to operate the aerosol generating device 1000. The battery 1040 may supply power such that the heater 1050 may be heated. In addition, the battery 1040 may supply power required for operations of other components (e.g., the sensing unit 1020, the output unit 1030, the user input unit 1060, the memory 1070, and the communication unit 1080) in the aerosol generating device 1000. The battery 1040 may be a rechargeable battery or a disposable battery. For example, the battery 1040 may be a lithium polymer (LiPoly) battery, but is not limited thereto.

The heater 1050 may receive power from the battery 1040 to heat an aerosol generating material. Although not illustrated in FIG. 10, the aerosol generating device 1000 may further include a power conversion circuit (e.g., a direct current (DC)/DC converter) that converts power of the battery 1040 and supplies the same to the heater 1050. In addition, when the aerosol generating device 1000 generates aerosols in an induction heating method, the aerosol generating device 1000 may further include a DC/alternating current (AC) that converts DC power of the battery 1040 into AC power.

The controller 1010, the sensing unit 1020, the output unit 1030, the user input unit 1060, the memory 1070, and the communication unit 1080 may each receive power from the battery 1040 to perform a function. Although not illustrated in FIG. 10, the aerosol generating device 1000 may further include a power conversion circuit that converts power of the battery 1040 to supply the power to respective components, for example, a low dropout (LDO) circuit, or a voltage regulator circuit.

In an embodiment, the heater 1050 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1050 may be implemented by a metal wire, a metal plate on which an electrically conductive track is arranged, a ceramic heating element, or the like, but is not limited thereto.

In another embodiment, the heater 1050 may be a heater of an induction heating type. For example, the heater 1050 may include a suspector that heats an aerosol generating material by generating heat through a magnetic field applied by a coil.

The user input unit 1060 may receive information input from the user or may output information to the user. For example, the user input unit 1060 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 10, the aerosol generating device 1000 may further include a connection interface, such as a universal serial bus (USB) interface, and may connect to other external devices through the connection interface, such as the USB interface, to transmit and receive information, or to charge the battery 1040.

The memory 1070 is a hardware component that stores various types of data processed in the aerosol generating device 1000, and may store data processed and data to be processed by the controller 1010. The memory 1070 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1070 may store an operation time of the aerosol generating device 1000, the maximum number of puffs, the current number of puffs, at least one temperature profile, data on a user's smoking pattern, etc.

The communication unit 1080 may include at least one component for communication with another electronic device. For example, the communication unit 1080 may include a short-range wireless communication unit 1082 and a wireless communication unit 1084.

The short-range wireless communication unit 1082 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1084 may include a cellular network communication unit, an Internet communication unit, a computer network (e.g., local area network (LAN) or wide area network (WAN)) communication unit, or the like, but is not limited thereto. The wireless communication unit 1084 may also identify and authenticate the aerosol generating device 1000 within a communication network by using subscriber information (e.g., International Mobile Subscriber Identifier (IMSI)).

The controller 1010 may control general operations of the aerosol generating device 1000. In an embodiment, the controller 1010 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1010 may control the temperature of the heater 1050 by controlling supply of power of the battery 1040 to the heater 1050. For example, the controller 1010 may control power supply by controlling switching of a switching element between the battery 1040 and the heater 1050. In another example, a direct heating circuit may also control power supply to the heater 1050 according to a control command of the controller 1010.

The controller 1010 may analyze a result sensed by the sensing unit 1020 and control subsequent processes to be performed. For example, the controller 1010 may control power supplied to the heater 1050 to start or end an operation of the heater 1050 on the basis of a result sensed by the sensing unit 1020. As another example, the controller 1010 may control, based on a result sensed by the sensing unit 1020, an amount of power supplied to the heater 1050 and the time the power is supplied, such that the heater 1050 may be heated to a certain temperature or maintained at an appropriate temperature.

The controller 1010 may control the output unit 1030 on the basis of a result sensed by the sensing unit 1020. For example, when the number of puffs counted through the puff sensor 1026 reaches a preset number, the controller 1010 may notify the user that the aerosol generating device 1000 will soon be terminated through at least one of the display unit 1032, the haptic unit 1034, and the sound output unit 1036.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol-generating device comprising:
a heater configured to heat an aerosol-generating product;
a sensor configured to detect a user's puff; and
a processor electrically connected to the heater and the sensor,
wherein the processor is configured to:
obtain first remaining puff data based on pressure change data obtained through the sensor;
when the first remaining puff data satisfies a preset condition and a user input is received, obtain data regarding an inhalation pattern based on the pressure change data;
change the first remaining puff data to second remaining puff data based on the data regarding the inhalation pattern; and
supply power to the heater based on the second remaining puff data.

2. The aerosol-generating device of claim 1, wherein the first remaining puff data and the second remaining puff data comprise at least one of a remaining heating time and a number of remaining puffs.

3. The aerosol-generating device of claim 1, wherein the processor determines that the preset condition of the first remaining puff data is satisfied when a remaining heating time of the first remaining puff data is a preset time, or when a number of remaining puffs is a preset number of puffs.

4. The aerosol-generating device of claim 1, wherein the processor is further configured to:
detect whether the pressure change data is greater than a preset value; and
when the pressure change data is greater than the preset value, obtain the data regarding the inhalation pattern based on the pressure change data.

5. The aerosol-generating device of claim 1, wherein the processor is further configured to obtain the data regarding the inhalation pattern based on an accumulated value of a pressure change.

6. The aerosol-generating device of claim 5, wherein the accumulated value of the pressure change is obtained through an arithmetic operation on effective pressure change values, is included in the pressure change data, and is a negative value.

7. The aerosol-generating device of claim 1, wherein the data regarding the inhalation pattern comprises at least one of an amount of a pressure change per puff, a puff duration, and a puff interval.

8. The aerosol-generating device of claim 1, further comprising a display on which a user interface is displayed,
wherein the processor is further configured to, when the first remaining puff data satisfies the preset condition, output a user interface that guides the user input through the display.

9. The aerosol-generating device of claim 1, wherein the second remaining puff data is obtained by changing at least one of an additional heating time and a number of additional puffs in the first remaining puff data.

10. The aerosol-generating device of claim 1, wherein the processor is further configured to obtain the pressure change data by performing digital signal filter processing (DSP) on data output from the sensor.

11. An operating method of an aerosol-generating device, the operating method comprising:
obtaining first remaining puff data based on pressure change data obtained through the sensor;
when the first remaining puff data satisfies a preset condition and a user input is received, obtaining data regarding an inhalation pattern based on the pressure change data;
changing the first remaining puff data to second remaining puff data based on the data regarding the inhalation pattern; and
supplying power to the heater based on the second remaining puff data.

12. The operating method of claim 11, further comprising detecting whether the pressure change data is greater than a preset value; and
when the pressure change data is greater than the preset value, obtaining the data regarding the inhalation pattern based on the pressure change data.

13. The operating method of claim 11, further comprising obtaining the data regarding the inhalation pattern based on an accumulated value of a pressure change,
wherein the accumulated value of the pressure change is obtained through an arithmetic operation on effective pressure change values, is included in the pressure change data, and is a negative value.

14. The operating method of claim 11, further comprising, when the first remaining puff data satisfies the preset condition, outputting a user interface that guides the user input through the display.

15. The operating method of claim 11, further comprising obtaining the pressure change data by performing digital signal filter processing (DSP) on data output from the sensor.
